(19) United States
(12) Patent Application Publication
(10) Pub. No.: US 2012/0206122 A1
(43) Pub. Date: Aug. 16, 2012

(54) CONSTANT OFF TIME BOOST CONVERTER

(76) Inventors: Timothy Alan Dhuyvetter, Arnold, CA (US); Michael David Mulligan, Davis, CA (US)

(21) Appl. No.: 13/369,825

(22) Filed: Feb. 9, 2012

Related U.S. Application Data
(60) Provisional application No. 61/441,721, filed on Feb. 11, 2011.

(51) Int. Cl. G05F 3/02

(52) U.S. Cl. 323/311

(57) ABSTRACT

This document discusses, among other things, apparatus and methods for operating a voltage converter. In an example, a circuit for controlling a converter can include a comparator configured to receive an off-time charge voltage and an off-time threshold and to initiate a transition of a power transistor from an off-time state to an on-time state when the off-time charge voltage exceeds the off-time threshold, and a capacitor coupled to the comparator and configured to receive a voltage from an inductor in the off-time state and to provide the off-time charge voltage using the voltage from the inductor.

### CLAIM OF PRIORITY

This patent application claims the benefit of priority, under 35 U.S.C. Section 119(e), to Dhuyvetter et al., U.S. Provisional Patent Application Ser. No. 61/441,721, entitled “CONSTANT OFF TIME BOOST CONVERTER WITH WIDE SUPPLY OPERATION,” filed on Feb. 11, 2011 (Attorney Docket No. 2921.112PRV), which is hereby incorporated by reference herein in its entirety.

### BACKGROUND

Self-oscillating type voltage converters if properly designed can be inherently stable, do not normally need feed-forward slope compensation and can have high bandwidth. Self-oscillating type voltage converters can determine switching frequency by sensing output voltage. However, such control can be load dependent and not always desirable. For example, at light loads, self-oscillating type voltage converters can skip pulses to maintain regulation, thus, the switching frequency can become erratic and can fall into an audible range that can cause distraction or discomfort to nearby personnel.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example of a constant off-time boost converter.

FIG. 2 illustrates generally waveforms associated with operation of an example constant off-time boost converter.

FIG. 3 illustrates generally an example of a constant off-time boost converter.

FIG. 4 illustrates generally waveforms associated with operation of an example constant off-time boost converter.

FIG. 5 illustrates generally an example voltage converter including a compensation circuit.

### OVERVIEW

This document discusses, among other things, apparatus and methods of operating a voltage converter. In an example, a circuit for controlling a converter can include a comparator configured to receive an off-time charge voltage and an off-time threshold and to initiate a transition of a power switch, such as a power transistor, from an off-time state to an on-time state when the off-time charge voltage exceeds the off-time threshold, and a capacitor coupled to the comparator and configured to receive a voltage from an inductor in the off-time state and to provide the off-time charge voltage using the voltage from the inductor.

This section is intended to provide an overview of subject matter of the present patent application. It is not intended to provide an exclusive or exhaustive explanation of the invention. The detailed description is included to provide further information about the present patent application.

### DETAILED DESCRIPTION

The present inventors have recognized a self-oscillating boost voltage converter topology that can set a constant off-time for a given difference between the input voltage and the output voltage of the converter. The difference between the input voltage and the output voltage can depend on the current draw of the load in some examples. However, the difference between the input voltage and the output voltage can also depend on other factors, such as the charge state of a power source supplying the input voltage, for example. The converter topology described herein can provide a consistent switching frequency over a wide load range, and in some examples, can maintain a switching frequency at light load conditions that is outside a frequency range that is audible to most users.

FIG. 1 illustrates generally an example voltage converter 100 that can include first and second converter switches 101, 102, a controller 103, an inductor 104, and a current sensor 105. In certain examples, the converter 100 can provide power to a load 106. In an example, the converter 100 can include a load capacitor 107. The controller 103 can provide commands to the first and second converter switches 101, 102 to initiate current through the inductor 104 and then couple the current to the load 106. In certain examples, the first and second converter switches 101, 102 can be controlled in alternating fashion in terms of the state of each converter switch such that when the first converter switch 101 is conducting, herein referred to as the “on-time” of the converter 100, the second converter switch 102 can isolate the converter output 108 from the inductor 104. When the first converter switch 101 is not conducting, or is isolating the inductor 104 from ground, herein referred to as the “off-time” of the converter 100, the second converter switch 102 can provide a low impedance path between the converter output 108 and the inductor 104. In certain examples, during the off-time, when the second converter switch 102 is providing a low impedance path to couple the inductor current to the load 106, the voltage, V_{S}, at the inductor 104 can be used by the controller 103 to time the off-time interval. In an example, during the on-time, a current sensor 105 can measure inductor current to time the on-time interval. For example, as the inductor current reaches a threshold during the on-time of the converter 100, the first converter switch 101 can be turned off and the second converter switch 102 can be turned on to couple the inductor current to the load 106. In an example, one or both of the first and second converter switches 101, 102 can include a power transistor.

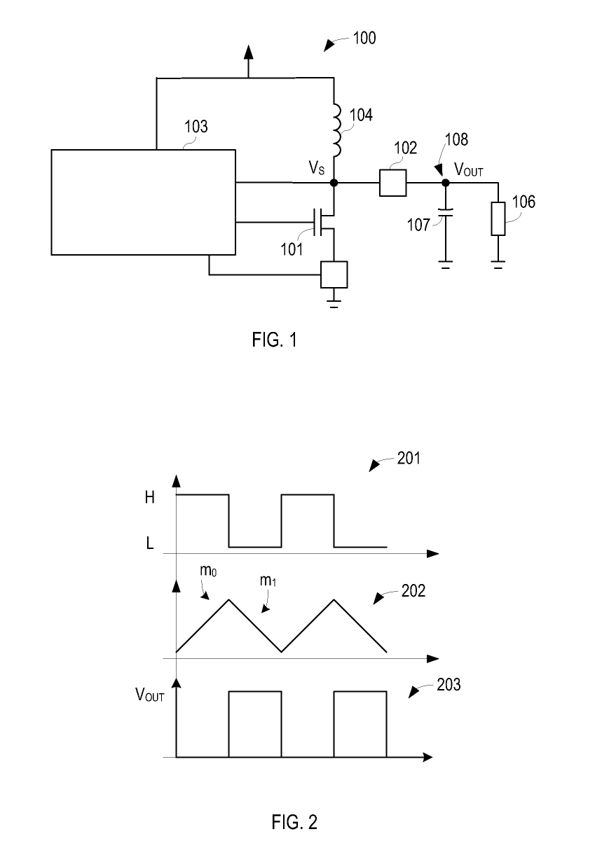

FIG. 2 illustrates generally example waveforms associated with an example converter. The first waveform 201 illustrates generally a command signal for the first converter switch in an example converter where the first converter switch includes an NMOS transistor. As the command signal goes high, H, the inductor can be coupled to ground and current can begin to flow through the inductor. The second waveform 202 illustrates generally the current through the inductor of the converter. When the inductor is coupled to ground, current through the inductor can gradually increase, e.g., at slope m₀. When the inductor is coupled to the load, the current can gradually decrease, e.g., at slope m₁. The third waveform 203 illustrates generally a voltage, V_{S}, at a node between the first converter switch and the inductor. The voltage, V_{S}, can be about ground when the first converter switch is on, and can be about equal to the output voltage V_{OUT}, when the inductor is coupled to the load through the second converter switch.

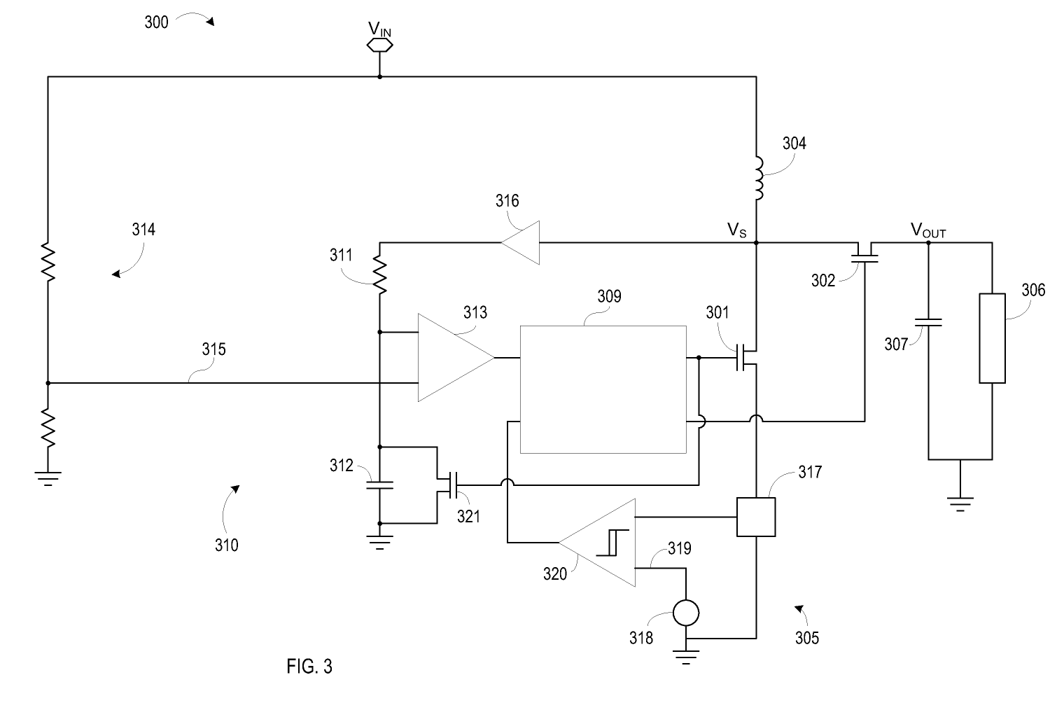

FIG. 3 illustrates generally an example voltage converter 300 having a frequency that can depend on the difference between the input voltage V_{IN} and the output voltage V_{OUT} and can be controllably adjusted independent of load conditions. In certain examples, the voltage converter 300 can be coupled to a load 306 and can include an inductor 304, first and second converter switches 301, 302, and a smoothing capacitor 307. Logic 309 can control the first and second converter switches 301, 302. In an example, the first converter switch 301 can initiate inductor current by coupling the inductor 304 between an input voltage V_{IN} and ground while the inductor 104 is isolated from the load 306 by the second converter switch 302. Energy stored in the inductor 304 via the current can be discharged to the load 306 by isolating the inductor 304 from ground using the first converter switch 301 and coupling the inductor 304 to the load 306 using the second converter switch 302. In an example, one or both of the first and second converter switches 301, 302 can include a power transistor.

In certain examples, the off-time of the converter 300 can be determined using a timing circuit 310 that can include a timing resistor 311, a capacitor 312, a comparator 313 and voltage divider 314. In an example, the voltage divider 314 can provide an off-time reference signal 315 to the comparator 313. The timing circuit 310 can be enabled when the inductor 304 is coupled to the load 306 via the second converter switch 302. A voltage, V_{S}, at the inductor 304 can charge the capacitor 312 until the voltage across the capacitor 312 reaches or exceeds a threshold, such as the off-time reference signal 315 generated from the voltage divider 314. The comparator 313 can provide an output indicative of the level of the capacitor voltage with respect to the off-time reference signal 315. In an example, the timing circuit 310 can include a buffer 316 to buffer the inductor 304 from the timing resistor 311, capacitor 312 and the comparator 313 of the timing circuit 310. In response to the output of the timing circuit comparator 313, logic 309 can switch the state of the first and second converter switches 301, 302 such that the inductor 304 can be isolated from the load 306 via the second converter switch 302 and the inductor 304 can be coupled to ground via the first converter switch 301. For purposes of this document, each interval of time that the first converter switch 301 couples the inductor to ground is the “on-time” of the converter 100. The on-time can continue until the current through the inductor 304 reaches a peak threshold. In certain examples, the converter 300 can include a current sense circuit 305 to detect and indicate a peak inductor current. In certain examples, the current sense circuit 305 can include a current sensor 317, to measure the current of the first converter switch 301, a reference source 318 to provide a peak current threshold 319, and a comparator 320. The comparator 320 can receive an output of the current sensor 317 and the peak current threshold 319, and can provide an output indicative of the current through the first converter switch 301 meeting or exceeding the peak current threshold 319. In an example, the reference source 318 can be programmable. In an example, the logic 309 can be responsive to the output of the current sense circuit 305 to trigger a transition from an on-time of the converter to an off-time of the converter. In an example, the logic 309 can be responsive to the output of the current sense circuit 305 to discontinue coupling the inductor 304 to ground through the first converter switch 301 and to begin coupling the charged inductor current to the load 306 through the second converter switch 302. In an example, a discharge switch 321 can discharge the capacitor 312 during the on-time of the converter 300.

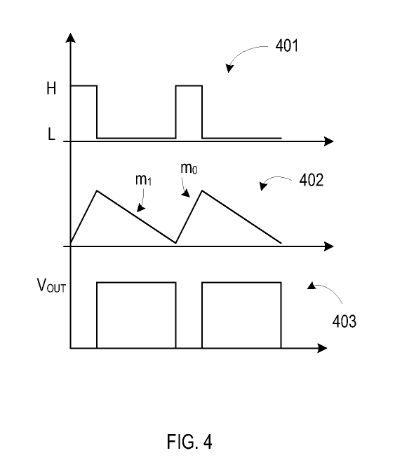

FIG. 4 illustrates generally example waveforms associated with an example voltage converter under light load conditions, or conditions when the input voltage V_{IN} is at or near the output voltage V_{OUT}, or when the input voltage V_{IN} is within a predetermined threshold of the output voltage V_{OUT}. The first waveform 401 illustrates generally the control signal for the first converter switch, such as an NMOS transistor. The second waveform 402 illustrates generally the inductor current. When the inductor is coupled to ground, current through the inductor can gradually increase, e.g., at slope m₀. When the inductor is coupled to the load, the current can gradually decrease, e.g., at slope m₁. The third waveform 403 illustrates the voltage at a node between the first converter switch and the inductor. Under light load conditions, the off-time of the first transistor can be extremely long as the output voltage V_{OUT} does not discharge as rapidly as when the converter is under a substantial load. In an example, as input voltage V_{IN} increases, the natural duty cycle of the first converter switch of the converter can fall to values that are too low to maintain stability at a first switching frequency. The input voltage V_{IN} can approach the converted output voltage for several reasons including, for example, a diminished amount of load current or a change in the condition of input voltage source, such as by re-charging. As duty cycle operation of the first converter switch becomes small, the on-time available for the first converter switch to change states and for the inductor current to reach the peak threshold can be too small for the converter to properly regulate voltage at the first switching frequency. Because the forward current loop path has a finite delay time and the on-time cannot be reduced further, present self oscillating converters will begin to skip on-time switching intervals to maintain stability. Such switching interval skipping can lower the switching frequency into an audible range that can be detected by a person or animal near the converter.

Abrupt on-time skipping can allow the switching frequency to be reduced to a frequency within an audible range. To alleviate abrupt on-time skipping, an example voltage converter can include compensation circuitry to change the switching frequency in a controlled manner to reduce, or substantially, delay the possibility of the switching frequency falling into an audible frequency range. In certain examples, a compensation signal proportional to the input voltage can be injected into the self-oscillating loop of the converter via the off-time reference signal. The compensation signal, via the off-time reference signal, can control the switching frequency and maintain stability of the converter control loop. In certain examples, the compensation signal can remain zero over certain ranges of the input voltage and then “kick-in” when the input voltage satisfies a threshold condition. In certain examples, the converter can maintain a constant switching frequency over one or more ranges of the input voltage.

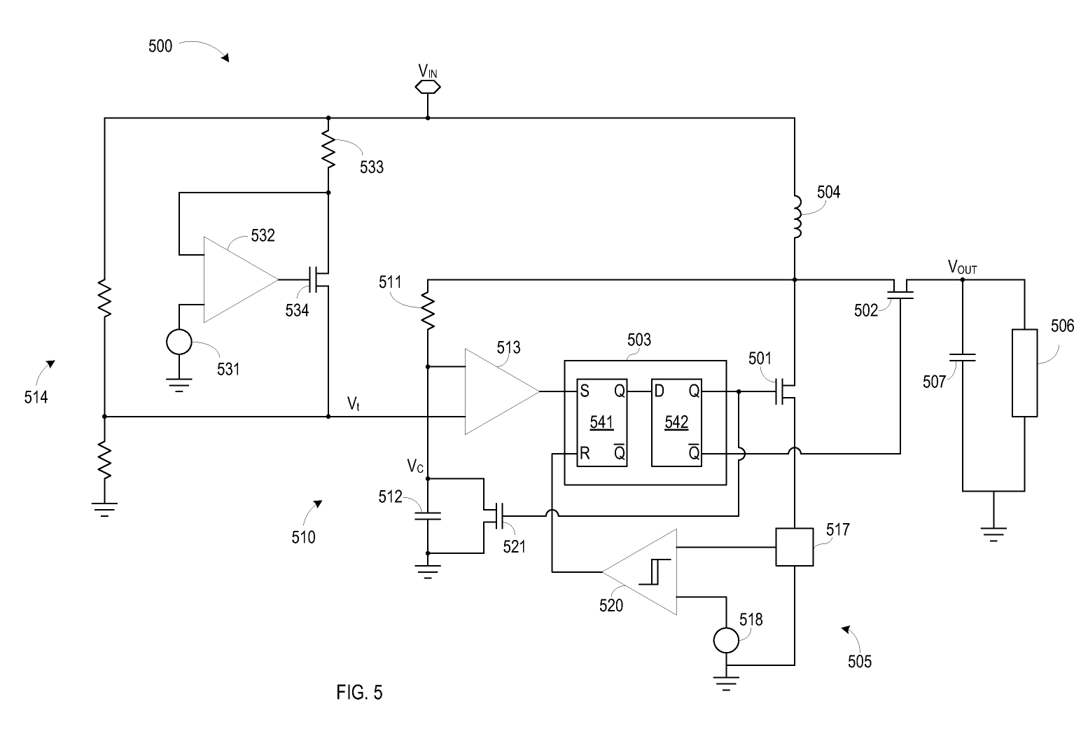

FIG. 5 illustrates generally an example converter 500 including a compensation circuit 530. The converter 500 can include first and second converter switches 501, 502, a current sense circuit 505, an off-time timing circuit 510, switching logic 503, and the compensation circuit 530. The switching logic 503 can control the first and second converter switches 501, 502. In an example, the first converter switch 501 can initiate inductor current by coupling an inductor 504 between an input voltage V_{IN} and ground while the inductor 504 is isolated from a load 506 by the second converter switch 502. Energy stored in the inductor 504 via the inductor current can be discharge to the load 506 by isolating the inductor 504 from ground using the first converter switch 501 and coupling the inductor 504 to the load 506 using the second converter switch 502. In an example, one or both of the first and second converter switches 501, 502 can include a power transistor.

In certain examples, the off-time of the converter 500 can be determined using the off-time timing circuit 510. The off-time timing circuit 510 can include a timing resistor 511, a capacitor 512, a comparator 513, and a voltage divider 514. The voltage divider 514 can provide an off-time reference signal 515 to the comparator 513. The off-time timing circuit 510 can be enabled when the inductor 504 is coupled to the load 506. A voltage, V_{S}, at the inductor 504 can charge the capacitor 512 until the voltage across the capacitor 512 reaches or exceeds a threshold, such as the off-time reference signal 515 generated from the voltage divider 514. When the capacitor 512 charges to the level of the off-time reference signal 515, the comparator 513 output can change logic levels. In response to the output of the comparator 513 indicating the completion of the off-time interval, the switching logic 503 can switch the state of the second converter switch 502 such that the inductor 504 can be isolated from the load 506 and can switch the state of the first converter switch 501 to couple the inductor 504 to ground. The on-time of the converter 500 can continue until the inductor current charges, or reaches, a peak threshold. In certain examples, a current sense circuit 505 can include a current sensor 517, a comparator 520 and a reference source 518. The current sensor 517 can provide a signal indicative of the amount of inductor current passing through the first converter switch 501. The comparator 520 can receive the output of the current sensor 517 and can provide an output indicative of whether the current through the first converter switch 501 meets or exceeds the level of the reference source 518. When the output of the comparator 520 indicates the current through the first converter switch 501 is at a peak level indicative of the level of the reference source 518, the switching logic 503 can switch the first and second converter switches 501, 502 to the off-time of the converter 100. In an example, a discharge switch 521 can discharge the capacitor 512 during the on-time of the converter 100.

In an example, the duty cycle, D, of the first converter switch 501 can be expressed as:

$$D = \frac{{V}_{OUT} + {V}_{IN}}{{V}_{OUT}} .$$

The slope of the charging current, m₁, of the inductor 504 with respect to time during charging of the inductor 504 can be expressed as,

$${m}_{1} = \frac{{V}_{IN}}{L} {t}_{ON} .$$

The slope of the discharge current, m2, of the inductor 504 with respect to time during discharge of the inductor 504 can be expressed as,

$${m}_{2} = \frac{{V}_{OUT} - {V}_{IN}}{L} {t}_{OFF} .$$

The ratio of the output voltage V_{OUT} to the input voltage V_{IN} can be the same as the ratio of the switching period, t_{pd}, to the off-time t_{OFF} of the first converter switch 501 such that,

$$\frac{{V}_{OUT}}{{V}_{IN}} = \frac{{t}_{pd}}{{t}_{OFF}}$$

Solving for the inverse of the switching period, the switching frequency, f, can be expressed as,

$$f = \frac{1}{{t}_{pd}} = \frac{{V}_{IN}}{{V}_{OUT}} \frac{1}{{t}_{OFF}} .$$

Assuming the conductance, g_{c}, of the compensation circuit 530 equals 0, the off-time of the first converter switch 501 is equal to the time the capacitor 512 charges to the threshold voltage Vₜ using the voltage at the inductor V_{S} as applied through the timing resistor 511. The threshold voltage Vₜ can be expressed as,

$${V}_{t} = \frac{{R}_{1}}{{R}_{0} + {R}_{1}} {V}_{IN} ,$$

and the capacitor voltage Vc can be expressed as,

$${V}_{c} = \frac{{V}_{OUT}}{{R}_{3} C} {t}_{OFF} .$$

Equating the voltages and solving for t_{OFF} provides,

$${t}_{OFF} = \frac{{CR}_{1} {R}_{3} {V}_{IN}}{( {R}_{0} + {R}_{1} ) {V}_{OUT}} .$$

Thus, the off-time of the converter 500 can be constant for a given ratio of the input voltage V_{IN} and the output voltage V_{OUT}.

As discussed above, when the input voltage V_{IN} approaches the output voltage V_{OUT}, the on-time available can become so small that the converter can become unstable and can skip on-time intervals to compensate. However, skipping on-time intervals can abruptly change the switching frequency and allow the switching frequency to become audible to a user. In an example, the converter 500 can include compensation circuitry 530 to controllably lower the switching frequency when the input voltage V_{IN} is within a threshold range of the output voltage V_{OUT}. In an example, the compensation circuitry 530 can include a reference source 531, a comparator 532, a resistor 533, and a transistor 534. In an example, the compensation circuit 530 can be thought of as an adjustable resistive element. The comparator 532 can compare a voltage representative of the input voltage V_{IN} to a reference voltage and provide a signal indicative of the comparison to control the transistor 534. In an example, when the representative input voltage is below the threshold voltage, the compensation circuit 530 does not provide a signal that alters the off-time reference signal 515. As the representative input voltage exceeds the threshold voltage, the compensation circuit 530 can inject current into the off-time reference signal 515 pulling the voltage level Vₜ of the off-time reference signal 515 higher. The higher voltage of the off-time reference signal 515 can result in a longer off-time and allow for an adequate on-time interval. In an example, when the input voltage V_{IN} exceeds the reference voltage, the threshold voltage Vₜ of the off-time reference signal can be expressed as,

$${V}_{t} = \frac{{R}_{1}}{\frac{{R}_{0} {R}_{4}}{{R}_{0} + {R}_{4}} + {R}_{1}} {V}_{IN} .$$

### Thus,

$${t}_{OFF} = \frac{{CR}_{1} {R}_{3} {V}_{IN}}{( \frac{{R}_{0} {R}_{4}}{{R}_{0} + {R}_{4}} + {R}_{1} ) {V}_{OUT}} ,$$

when V_{IN}>V_{REF}.

Logic 503 can control the first and second converter switches 501, 502. In an example, the first converter switch 501 can initiate inductor current by coupling the inductor 504 between an input voltage V_{IN} and ground while the inductor 504 is isolated from the load 506 by the second converter switch 502. Energy stored in the inductor 504 via the inductor current can be discharge to the load 506 by isolating the inductor 504 from ground using the first converter switch 501 and coupling the inductor 504 to the load 506 using the second converter switch 502.

In an example, the logic 503 can include a set-reset (S-R) flip-flop 541 and a D flip-flop 542. In certain example, the output of the off-time comparator 513 can be coupled to the set input, S, of the S-R flip-flop 541 and the output of the current sense circuit 505 can be coupled to the reset input, R. In an example, the D-flip-flop 542 can be a break-before-make (BBM) type flip-flop to ensure the first and second converter switches 501, 502 are not in a conducting state simultaneously. In an example, an output of the logic 503, such as an output of the D flip-flop 542, can be coupled to the gate of the first converter switch 501 and a complementary output of the D flip-flop 542 can be coupled to the gate of the second converter switch 502.

### Additional Notes

In Example 1, a converter can include an inductor having a first node coupled to a voltage source, a power transistor coupled to a second node of the inductor and to ground, a gate node of the power transistor configured to be coupled to an output of the circuit, wherein, during an on-time state, the power transistor configured to couple the inductor to ground to charge the inductor, and wherein, during an off-time state, the inductor is configured to be coupled to a load. A circuit for controlling the converter can include a comparator configured to receive an off-time charge voltage and an off-time threshold and to initiate a transition of the power transistor from the off-time state to the on-time state when the off-time charge voltage exceeds the off-time threshold, and a capacitor coupled to the comparator and configured to receive a voltage from the inductor in the off-time state and to provide the off-time charge voltage using the voltage from the inductor.

In Example 2, the circuit of Example 1 optionally includes an off-time reference circuit coupled to the voltage source and configured to provide the off-time threshold, the off-time reference circuit including an adjustable resistor configured to adjust the off-time threshold when a voltage of the voltage source is within a predetermined threshold of an output voltage of the converter.

In Example 3, the adjustable resistor of any one or more of Examples 1-2 optionally includes frequency compensation transistor configured to provide a frequency compensation signal with the off-time threshold when the voltage of the voltage source is within the predetermined threshold of the output voltage of the converter.

In Example 4, the adjustable resistor of any one or more of Examples 1-3 optionally includes a frequency compensation comparator coupled to a control node of the frequency compensation transistor, the frequency compensation comparator configured to compare the voltage of the voltage source to a frequency threshold voltage to drive the frequency compensation transistor.

In Example 5, the off-time reference circuit of any one or more of Examples 1-4 optionally includes an adjustable resistor configured to increase the off-time threshold when a voltage of the voltage source is within a predetermined threshold of an output voltage of the converter.

In Example 6, the circuit of any one or more of Examples 1-5 optionally includes a buffer configured to buffer a charge current of the capacitor from the inductor.

In Example 7, the circuit of any one or more of Examples 1-6 optionally includes a current sense circuit configured to compare current of the inductor to a reference peak current during the on-time state and to trigger a transition from the on-time state to the off-time state when the inductor current is substantially equal to the reference peak current.

In Example 8, the circuit of any one or more of Examples 1-7 optionally includes a flip-flop circuit configured to control provide a control signal to the power transistor, wherein the flip-flop circuit includes a first input coupled to an output of the comparator and a second input coupled to an output of the current sense circuit.

In Example 9, the circuit of any one or more of Examples 1-8 optionally includes a discharge transistor configured to discharge the capacitor during the on-time state.

In Example 10, a method for controlling a converter, such as the converter of any one or more of Examples 1-9, can include providing an off-time threshold using an off-time reference circuit coupled to the voltage source, providing an off-time charge voltage during the off-time state using a capacitor coupled to the inductor and a comparator, comparing the off-time charge voltage to the off-time threshold at the comparator, and initiating a transition from the off-time state to an on-time state using an output of the comparator.

In Example 11, the method of any one or more of Examples 1-10 optionally includes adjusting the off-time threshold when a voltage of the voltage source is within a predetermined threshold of an output voltage of the converter using an adjustable resistor of the off-time reference circuit.

In Example 12, the adjusting the off-time threshold of any one or more of Examples 1-11 optionally includes providing a frequency compensation signal with the off-time threshold when the voltage of the voltage source is within the predetermined threshold of the output voltage of the converter.

In Example 13, the providing the frequency compensation signal of any one or more of Examples 1-12 optionally includes comparing the voltage of the voltage source to a frequency threshold voltage to drive a frequency compensation transistor coupled to an output of the off-time reference circuit.

In Example 14, the adjusting the off-time threshold of any one or more of Examples 1-13 optionally includes increasing the off-time threshold when a voltage of the voltage source is within a predetermined threshold of an output voltage of the converter.

In Example 15, the method of any one or more of Examples 1-14 optionally includes buffering a charge current of the capacitor from the inductor.

In Example 16, the method of any one or more of Examples 1-15 optionally includes receiving a representation of inductor current during the on-time state at a peak current comparator, comparing the representation of the on-time current of the inductor current to a peak current threshold, and initiating a transition from the on-time state to the off-time state when using the peak current threshold comparison.

In Example 17, the method of any one or more of Examples 1-2 optionally including receiving an output of the comparator at a first input of a flip-flop, receiving an output of the peak current comparator at a second input of the flip-flop, and providing a first control signal to a gate of the power transistor.

In Example 18, the method of any one or more of Examples 1-2 optionally includes discharging the capacitor during the on-time state.

In Example 19, a system can include a converter and circuit configured to control the converter. The converter can include an inductor having a first node coupled to a voltage source, a power transistor coupled to a second node of the inductor and to ground, a gate node of the power transistor configured to be coupled to an output of the circuit, wherein, during an on-time state, the power transistor configured to couple the inductor to ground to charge the inductor, and wherein, during an off-time state, the inductor is configured to be coupled to a load. The circuit to control the converter can include a comparator configured to receive an off-time charge voltage and an off-time threshold and to initiate a transition of the power transistor from the off-time state to the on-time state when the off-time charge voltage exceeds the off-time threshold, a capacitor coupled to the comparator and configured to receive a voltage from the inductor in the off-time state and to provide the off-time charge voltage using the voltage from the inductor, an off-time reference circuit coupled to the voltage source and configured to provide the off-time threshold, the off-time reference circuit including an adjustable resistor configured to adjust the off-time threshold when a voltage of the voltage source is within a predetermined threshold of an output voltage of the converter, and a current sense circuit configured to compare current of the inductor to a reference peak current during the on-time state and to trigger a transition from the on-time state to the off-time state when the inductor current is substantially equal to the reference peak current.

In Example 20, the off-time reference circuit of any one or more of Examples 1-19 optionally includes an adjustable resistive element configured to increase the off-time threshold when a voltage of the voltage source is within a predetermined threshold of an output voltage of the converter.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, although the examples above have been described relating to PNP devices, one or more examples can be applicable to NPN devices. In other examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A circuit for controlling a converter, the converter including an inductor having a first node coupled to a voltage source, a power transistor coupled to a second node of the inductor and to ground, a gate node of the power transistor configured to be coupled to an output of the circuit, wherein, during an on-time state, the power transistor configured to couple the inductor to ground to charge the inductor, and wherein, during an off-time state, the inductor is configured to be coupled to a load, the circuit comprising:
a comparator configured to receive an off-time charge voltage and an off-time threshold and to initiate a transition of the power transistor from the off-time state to the on-time state when the off-time charge voltage exceeds the off-time threshold; and
a capacitor coupled to the comparator and configured to receive a voltage from the inductor in the off-time state and to provide the off-time charge voltage using the voltage from the inductor.

2. The circuit of claim 1, including an off-time reference circuit coupled to the voltage source and configured to provide the off-time threshold, the off-time reference circuit including an adjustable resistor configured to adjust the off-time threshold when a voltage of the voltage source is within a predetermined threshold of an output voltage of the converter.

3. The circuit of claim 2, wherein the adjustable resistor includes frequency compensation transistor configured to provide a frequency compensation signal with the off-time threshold when the voltage of the voltage source is within the predetermined threshold of the output voltage of the converter.

4. The circuit of claim 3, wherein the adjustable resistor includes a frequency compensation comparator coupled to a control node of the frequency compensation transistor, the frequency compensation comparator configured to compare the voltage of the voltage source to a frequency threshold voltage to drive the frequency compensation transistor.

5. The circuit of claim 1, wherein the off-time reference circuit includes an adjustable resistor configured to increase the off-time threshold when a voltage of the voltage source is within a predetermined threshold of an output voltage of the converter.

6. The circuit of claim 1, including a buffer configured to buffer a charge current of the capacitor from the inductor.

7. The circuit of claim 1, including a current sense circuit configured to compare current of the inductor to a reference peak current during the on-time state and to trigger a transition from the on-time state to the off-time state when the inductor current is substantially equal to the reference peak current.

8. The circuit of claim 7, including a flip-flop circuit configured to control provide a control signal to the power transistor, wherein the flip-flop circuit includes a first input coupled to an output of the comparator and a second input coupled to an output of the current sense circuit.

9. The circuit of claim 1, including a discharge transistor configured to discharge the capacitor during the on-time state.

10. A method for controlling a converter, the converter including an inductor having a first node coupled to a voltage source, a power transistor coupled to a second node of the inductor and to ground, wherein, during an on-time state, the power transistor couples the inductor to ground to charge the inductor, and wherein, during an off-time state, the inductor is configured to be coupled to a load, the method comprising:
providing an off-time threshold using an off-time reference circuit coupled to the voltage source;
providing an off-time charge voltage during the off-time state using a capacitor coupled to the inductor and a comparator;
comparing the off-time charge voltage to the off-time threshold at the comparator; and
initiating a transition from the off-time state to an on-time state using an output of the comparator.

11. The method of claim 10, including adjusting the off-time threshold when a voltage of the voltage source is within a predetermined threshold of an output voltage of the converter using an adjustable resistor of the off-time reference circuit.

12. The method of claim 11, wherein the adjusting the off-time threshold includes providing a frequency compensation signal with the off-time threshold when the voltage of the voltage source is within the predetermined threshold of the output voltage of the converter.

13. The method of claim 12, wherein the providing the frequency compensation signal includes comparing the voltage of the voltage source to a frequency threshold voltage to drive a frequency compensation transistor coupled to an output of the off-time reference circuit.

14. The method of claim 11, wherein the adjusting the off-time threshold includes increasing the off-time threshold when a voltage of the voltage source is within a predetermined threshold of an output voltage of the converter.

15. The method of claim 10, including buffering a charge current of the capacitor from the inductor.

16. The method of claim 10, including receiving a representation of inductor current during the on-time state at a peak current comparator;
comparing the representation of the on-time current of the inductor current to a peak current threshold; and
initiating a transition from the on-time state to the off-time state when using the peak current threshold comparison.

17. The method of claim 16, including:
receiving an output of the comparator at a first input of a flip-flop;
receiving an output of the peak current comparator at a second input of the flip-flop; and
providing a first control signal to a gate of the power transistor.

18. The method of claim 10, including discharging the capacitor during the on-time state.

19. A system comprising:
a converter, the converter including:
an inductor having a first node coupled to a voltage source;
a power transistor coupled to a second node of the inductor and to ground, a gate node of the power transistor configured to be coupled to an output of the circuit;
wherein, during an on-time state, the power transistor configured to couple the inductor to ground to charge the inductor; and
wherein, during an off-time state, the inductor is configured to be coupled to a load; and
a circuit configured to control the converter, the circuit including:
a comparator configured to receive an off-time charge voltage and an off-time threshold and to initiate a transition of the power transistor from the off-time state to the on-time state when the off-time charge voltage exceeds the off-time threshold;
a capacitor coupled to the comparator and configured to receive a voltage from the inductor in the off-time state and to provide the off-time charge voltage using the voltage from the inductor;
an off-time reference circuit coupled to the voltage source and configured to provide the off-time threshold, the off-time reference circuit including an adjustable resistor configured to adjust the off-time threshold when a voltage of the voltage source is within a predetermined threshold of an output voltage of the converter; and
a current sense circuit configured to compare current of the inductor to a reference peak current during the on-time state and to trigger a transition from the on-time state to the off-time state when the inductor current is substantially equal to the reference peak current.

20. The system of claim 19, wherein the off-time reference circuit includes an adjustable resistive element configured to increase the off-time threshold when a voltage of the voltage source is within a predetermined threshold of an output voltage of the converter.
